(19) United States
(12) Patent Application Publication
(10) Pub. No.: US 2009/0043806 A1
(43) Pub. Date: Feb. 12, 2009

(54) EFFICIENT TUPLE EXTRACTION FROM STREAMING XML DATA

(75) Inventors: Wook-Shin Han, Daegu (KR); Ching-Tien Ho, San Jose, CA (US); Haifeng Jiang, San Jose, CA (US); Quanzhong Li, San Jose, CA (US)

Correspondence Address: IBM - ARC;SHIMOKAJI & ASSOCIATES, P.C., 8911 RESEARCH DRIVE, IRVINE, CA, 92618, US

(73) Assignee: INTERNATIONAL BUSINESS MACHINES CORPORATION, Armonk, NY (US)

(21) Appl. No.: 12/134,080

(22) Filed: Jun. 5, 2008

Related U.S. Application Data
(63) Continuation of application No. 11/835,901, filed on Aug. 8, 2007.

(51) Int. Cl. G06F 17/30; G06F 7/00

(52) U.S. Cl. 707/102; 707/E17.05; 707/E17.054; 707/E17.014

(57) ABSTRACT

A method and apparatus are disclosed for querying streaming extensible markup language (XML) data comprising: routing elements to query nodes, the elements derived from the streaming extensible markup language data; filtering out elements not conforming to one or more predetermined path query patterns; adding remaining elements to one or more dynamic element lists; accessing a decision table to select and return a query node related to a cursor element from the dynamic element lists; and processing the cursor element related to the returned query node to produce an extracted tuple output.

### BACKGROUND OF THE INVENTION

The present invention relates generally to Extensible Markup Language (XML) queries. More specifically, the present invention is related to a method for extracting tuple data from streaming, hierarchical XML data.

Querying streaming XML data has become an important task executed by modern information processing systems. XML queries specify patterns of selection predicates on multiple elements having some structural relationships, such as, for example, parent-child and ancestor-descendant. Streaming XML data arrives in an orderly format, typically as a sequence of Simple Application Program Interface (API) for XML events (i.e., SAX events or elements), where an SAX event or element may include a start element (SE), attributes, an end element (EE) and text. For example, if an XML data tree 11, in FIG. 1, is served in a streaming format, a resulting sequence of SAX events may comprise the following elements: SE(a₁), SE(b₁), EE(b₁), SE(b₂), EE(b₂), EE(a₁), SE(a₂), SE(b₃), EE(b₃), SE(c₁), EE(c₁), and EE(a₂). It can thus be appreciated that when the XML data is accessed in a streaming fashion, the element ‘c₁’, for example, will not be seen until the a-elements and the b-elements have been seen first.

In contrast to XML data that is parsed and stored in databases, streaming XML data can be most efficiently processed by consuming such SAX events without reliance on extensive buffering for storage of parsed data. Streaming XML data can be modeled as a tree, where nodes represent elements, attributes and text data, and parent-child pairs represent nestings between XML element nodes. XML data tree nodes are often encoded with positional information for efficient evaluation of their positional relationships. A core operation in XML query processing is locating all occurrences of a twig pattern, that is, a small tree pattern with elements and string values as nodes.

In mapping-based XML transformations, it is a common requirement that mapped values be extracted from streaming XML data sources. For example, tuple extraction is shown to be a core operation for data transformation in schema-mapping systems. XML tuple-extraction queries may comprise XML pattern queries with multiple extraction nodes. A tuple-extraction query can be represented as a labeled query tree with one or multiple extraction nodes. As used herein, a query tree node may be referred to as a ‘query node’ or a ‘QNode.’ The extracted values may be in the form of ‘flat tuples’ (i.e., data formatted into rows), which are then transformed to the target based on a mapping specification. However, tuple extraction may be a computationally-expensive operation in the integrated processing of XML data and relational data. For example, subsequent to the extraction of a tuple data stream from an XML data source, the tuple data stream may be sent to a relational operator for further processing, such as joining with other relational tables.

Recent efforts to improve streaming XML processing have produced XML filtering methods, such as XFilter, or have taken the approach of intentionally limiting XML processing operations to single extraction nodes by not including multiple extraction nodes. One method has utilized an algorithm known as ‘TurboXPath’ for tuple extraction from streaming XML data, but the application of TurboXPath has resulted in exponentially-increasing complexity when dealing with recursions. Moreover, although most Extensible Style Language Transformation (XSLT) XQuery engines can support tuple extraction queries, most XSLT/XQuery engines do not provide satisfactory performance as a consequence of efficiency and scalability problems. These efforts have, accordingly, produced limited results in attempting to provide efficient algorithms for tuple extraction.

FIG. 2 is an example of an XML data tree 13 representing XML data that may be obtained from a database such as the Digital Bibliography & Library Project (DBLP). The XML data tree 13 comprises a root 15 (i.e., element ‘dblp’) at ‘zero level.’ XML data tree nodes are assigned with ‘region encoding’ triplets having a ‘start’ value, an ‘end’ value, and a ‘level’ value. The root 15 is a DBLP element spanning from start position ‘1’ to end position ‘20’, having a level value of ‘zero’. A first ‘inproceedings’ element 17, for example, spans from start position ‘2’ to end position ‘11’, and a second ‘inproceedings’ element 19 spans from start position ‘12’ to end position ‘19’, where both ‘inproceedings’ elements 17 and 19 have level values of ‘one’. ‘Level values’ record the distance from a root element to the respective element. Such region encoding supports efficient evaluation of ancestor-descendant or parent-child relationship between element nodes. In more formal terms, element ‘u’ is an ancestor of element ‘v’ if and only if u.start<v.start<u.end. For a parent-child relationship, it holds that u.level=v.level−1.

As used herein, a virigule, or single forward slash, ‘/’ represents a parent-child relationship between a QNode and its parent, a double virigule ‘//’ represents an ancestor-descendant relationship, and a pound symbol ‘#’ represents an extraction node. Generally, a full match of a tuple-extraction pattern Q in an XML database D, modeled as a tree, may be identified by a mapping from nodes in Q to nodes in D, such that: (i) QNode predicates, if any, are satisfied by the corresponding database D nodes; and (ii) the ancestor-descendant structural relationships or the parent-child structural relationships between QNodes are satisfied by the corresponding database D nodes.

The full match of the tuple-extraction pattern Q can be represented as an n-ary relation, where each tuple (e₁; e₂; . . . ; eₙ) comprises database D nodes. For the extraction nodes in the tuple-extraction pattern Q, corresponding text values are associated with the matched element nodes. The answer to a tuple-extraction query thus comprises the set of full-match tuples projected onto the extraction nodes.

A second tuple-extraction pattern 21, in FIG. 3, may function to extract from the XML data tree 13 a set of triplets having a format of [title, author, year]. The tuple-extraction pattern 21 may be represented by the pseudo XPath query below, also shown in FIG. 3:

/dblp/inproceedings [title# and author# and year#]

For example, given the XML data tree 13 in FIG. 2 and the extraction pattern 21 in FIG. 3, three full match tuples may be obtained as shown in Table 1, below, where each element in Table 1 is identified with a corresponding region code. The extraction nodes elements may also be attached with text values. To obtain a tuple-extraction query answer from the full matches of Table 1, the full-match tuples may be projected onto extraction node columns, and region codes may be omitted after the projection.

TABLE 1
Full Query Matches

| Tuple | DBLP | inproc. | title | author |
|---|---|---|---|---|
| t₁ | (1, 20, 0) | (2, 11, 1) | (3, 4, 2):T1 | (7, 8, 2):A1 |
| t₂ | (1, 20, 0) | (2, 11, 1) | (3, 4, 2):T1 | (9, 10, 2):A2 |
| t₃ | (1, 20, 0) | (12, 19, 1) | (13, 14, 2):T2 | (17, 18, 2):A1 |

U.S. Pat. No. 7,219,091 “Method and system for pattern matching having holistic twig joins” discloses holistic twig joins as a method for improving the matching of XML patterns over XML data stored in databases. The holistic twig join method reads the entire XML data input and uses a chain of linked stacks to compactly represent partial results for root-to-leaf query paths. The query paths are composed to obtain matches for a twig pattern that may use ancestor-descendant relationships between elements. However, the method practiced in the reference assumes that the XML data has been parsed and has been encoded with region codes prior to pattern matching. A holistic twig-join algorithm is described, the algorithm designed to avoid irrelevant intermediate results and to achieve optimal worst-case I/O and CPU cost (i.e., a cost that is a linear function of the total size of input and output data).

Operation of the holistic twig-joining algorithm may be explained by reference to the XML data tree 13, to a query 23, shown in FIG. 4, and to Table 2, shown below. As the holistic twig-join algorithm begins execution, stacks corresponding to ‘Cₐ’, ‘C_{b}’, and ‘C_{c}’ are empty and all cursors point to the first element of the corresponding data stream. In Table 2 below, there are listed cursor elements as found after each call of the holistic twig-joining algorithm for the query 23. As a convention, the cursor element of a returned QNode is identified by being enclosed within parentheses in Table 2. After the first call, the cursor elements may be (a₂; b₁; c₁). The cursor of extracting QNode ‘qₐ’ may then be forwarded from ‘a₁’ to ‘a₂’. Given that ‘a₂’ is not a common ancestor of ‘b₁’ and ‘c₁’, the value of the extracting QNode ‘q_{b}’ may be returned. The cursor element ‘C_{qb}’ may be forwarded to ‘b₂’ after the element ‘b₁’ has been consumed. Similarly, the second call of the holistic twig-joining algorithm may also return ‘q_{b}’ with the element ‘b₂’. Both elements ‘b₁’ and ‘b₂’ may be discarded because no a-element had been returned. At the third call of the holistic twig-joining algorithm, the root ‘qₐ’ may be returned because the current cursors make up a solution extension. The procedure may be concluded after the cursor element ‘c₁’ has been returned.

TABLE 2
Cursor Elements

| | init | 1 | 2 | 3 | 4 | 5 | 6 |
|---|---|---|---|---|---|---|---|
| Cₐ | a₁ | a₂ | a₂ | (a₂) | end | end | end |
| C_{b} | b₁ | (b₁) | (b₂) | b₃ | (b₃) | end | end |
| C_{c} | c₁ | c₁ | c₁ | c₁ | c₁ | (c₁) | end |

It can thus be appreciated by one skilled in the art that use of a holistic twig-joining algorithm is not directly applicable to the extraction of tuple data from streaming, hierarchical XML data, because the algorithm requires valid cursor elements to begin execution. Additionally, such holistic cursors are “uncoordinated,” wherein each cursor aggressively searches for its next element without considering other cursors.

Another problem arises in that holistic twig-joining procedures typically require encoded XML element lists for operation, and thus may not operate on streaming XML data lists. However, it is not practical to adapt the holistic twig-joining algorithm to handle streaming XML by parsing the incoming XML data, storing the parsed XML data in temporary files, and then running the algorithm. This parsing method may cause unnecessary inputs/outputs (I/Os) because all the incoming data needs to be stored and then read back to run the holistic twig-joining algorithm. Additionally, the parsing method would require an impractically-large temporary storage device to handle the continuous streaming XML data.

From the above, it is clear that there is a need for an efficient and scalable method of extracting tuple data from streaming, hierarchical XML data without the need for parsing and storing large amounts of data.

### SUMMARY OF THE INVENTION

In one aspect of the present invention, a method for querying streaming extensible markup language data comprises: routing elements to query nodes, the elements derived from the streaming extensible markup language data; filtering out elements not conforming to one or more predetermined path query patterns; adding remaining elements to one or more dynamic element lists; accessing a decision table to select and return a query node related to a cursor element from the dynamic element list; and processing the cursor element related to the returned query node to produce an extracted tuple output.

In another aspect of the present invention, a method for conducting a query to extract tuple data from a data warehouse database comprises: parsing data from the data warehouse database into a plurality of simple application program interface for extensible markup language (SAX) elements; discarding selected SAX elements, the selected SAX elements not conforming to path query patterns based on the query, the path query patterns ending at one or more query nodes corresponding to the SAX elements; appending at least one SAX element to a tail of a dynamic element list; returning a query node related to a cursor in the dynamic element list; and processing the cursor element via a process of holistic twig join matching.

In another aspect of the present invention, an apparatus for executing a query plan comprises: a data storage device; a computer program product in a computer useable medium including a computer readable program, wherein the computer readable program when executed on the apparatus causes the apparatus to: access an extensible markup language data parser to parse data from the data storage device into a plurality of elements; route the elements to query nodes; add the elements conforming to a query plan pattern to a dynamic element list; access a decision table to obtain a query node related to a cursor element from the dynamic element list; and process the cursor element to produce an extracted tuple output.

These and other features, aspects and advantages of the present invention will become better understood with reference to the following drawings, description and claims.

### BRIEF DESCRIPTION OF THE DRAWINGS

FIG. 1 is a diagrammatical illustration of an XML data tree, in accordance with the prior art;

FIG. 2 is a diagrammatical illustration of an XML data tree having tree nodes assigned with triplet region encoding, in accordance with the prior art;

FIG. 3 is a diagrammatical illustration of a tuple-extraction pattern, in accordance with the prior art;

FIG. 4 is a diagrammatical illustration of a query, in accordance with the prior art;

FIG. 5 is a diagrammatical illustration of a conventional data processing system comprising a computer, the data processing system suitable for extracting tuple data from streaming, hierarchical XML data, in accordance with the present invention;

FIG. 6 is a diagrammatical illustration of modules in a computer process for extracting tuple data from streaming, hierarchical XML data, in accordance with the present invention;

FIG. 7 is a listing of code lines for a core subroutine residing in the process of FIG. 6, in accordance with the present invention;

FIG. 8 is a decision table for the core subroutine of FIG. 7, in accordance with the present invention;

FIG. 9 is a diagrammatical illustration of an XML data tree having tree nodes assigned with triplet region encoding, in accordance with the present invention;

FIG. 10 is a query with input lists associated with the XML data tree of FIG. 9;

FIG. 11 is a table providing running statistics without existential matching for the core subroutine of FIG. 7, in accordance with the present invention;

FIG. 12 is a table providing running statistics after SAX events for the core subroutine of FIG. 7; and

FIG. 13 is a flow diagram describing operation of the process of FIG. 6, in accordance with the present invention.

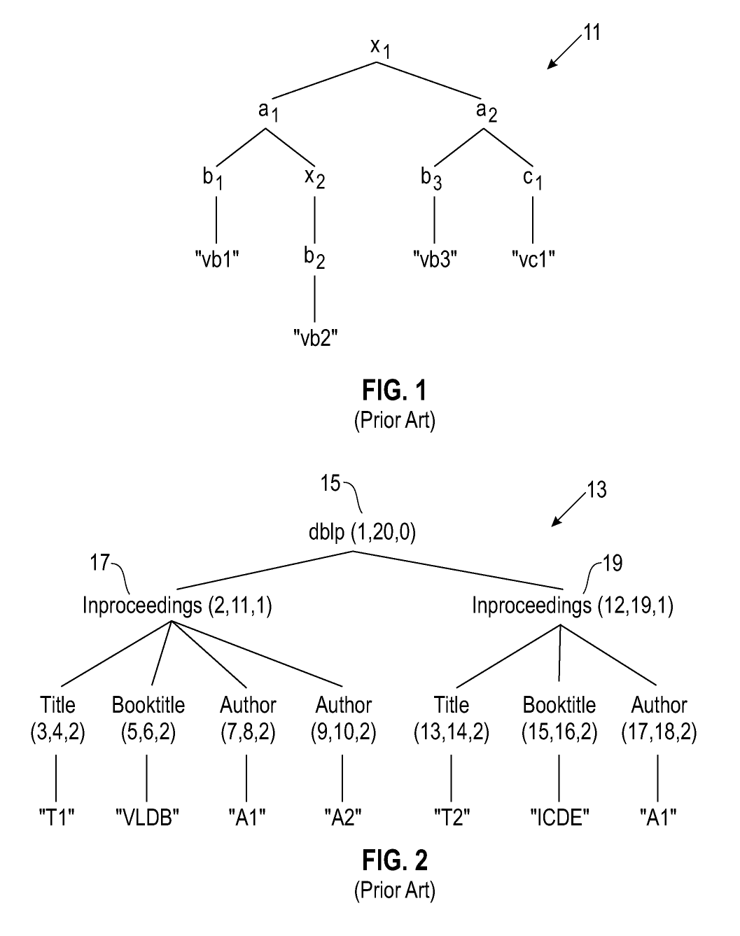

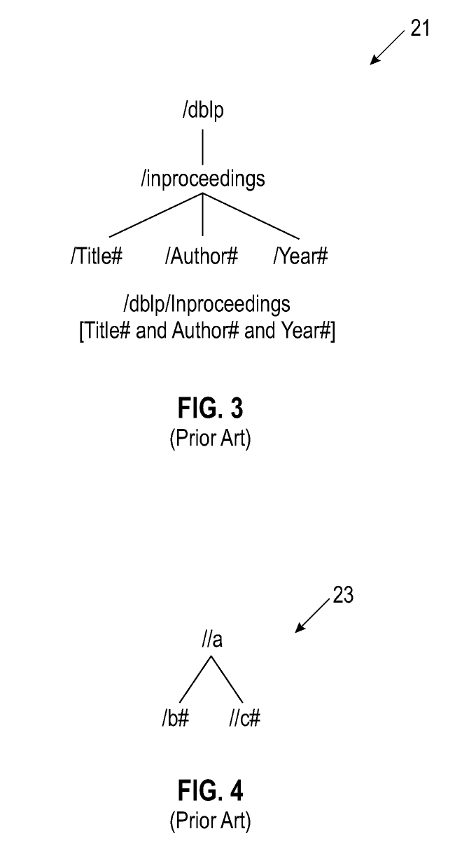

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

As can be appreciated by one skilled in the art, many organizations and other repositories store data in XML format. Such data may include, for example, media articles, technical papers, Internet web documents, commodity purchase orders, product catalogs, client support documentation, and archived commercial transactions. The process of searching large data files, such as catalogs and lengthy articles, may require parsing of a document and performing a search for particular keywords or key phrases. Accordingly, the present invention generally provides a method for extracting tuple data from streaming, hierarchical XML data as may be adapted to information processing systems, where the parsing process and the algorithms may be implemented using C++.

The disclosed method and apparatus may include a block-and-trigger mechanism applied during holistic matching of XML patterns over XML data such that incoming XML data is consumed in a best-effort fashion without compromising the optimality of holistic matching, and such that cursors are coordinated. The blocking mechanism causes some incoming data to be buffered, but the disclosed method produces a ‘peak’ demand for buffer space that is smaller than buffer space required when parsing and storing the XML data in order to be able to execute a holistic twig-join algorithm, as may be found in conventional systems.

In an optional embodiment of the present invention, a pruning technique may be deployed to further reduce the buffer sizes in comparison to a process not using a pruning technique. In particular, a query-path pruning technique may function to ensure that each buffered XML element satisfies its query path. Additionally, an existential-match pruning technique may function to ensure that only those XML elements that participate in final results are buffered, so as to reduce memory or storage requirements, in comparison to the prior art.

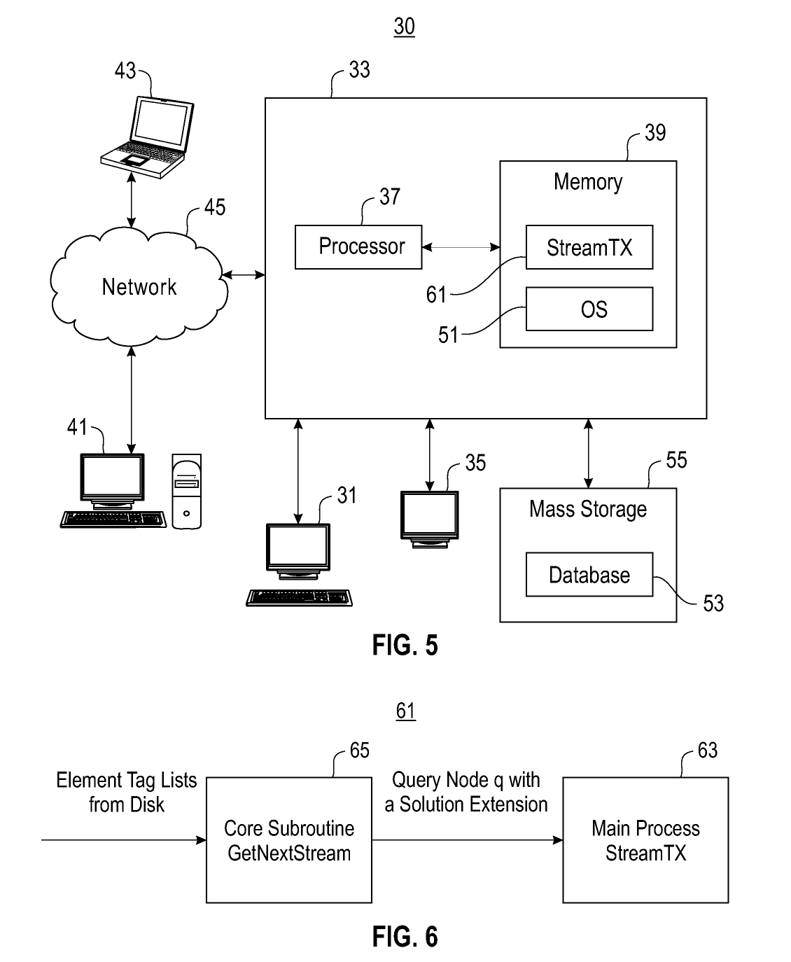

FIG. 5 shows a data processing system 30, such as may be embodied in a computer, a computer system, or similar programmable electronic system, and can be a stand-alone device or a distributed system as shown. The data processing system 30 may be responsive to a user input via a workstation 31 and may comprise at least one local computer 33 having a display 35, and a processor 37 in communication with a memory 39. The local computer 33 may interface with a remote personal computer 41 and a remote portable computer 43 via a network 45, such as a LAN, a WAN, a wireless network, and the Internet. The local computer 33 may operate under the control of an operating system 51 in communication with a database 53 located in a mass storage device 55, for example. The local computer 33 may further function to execute a StreamTX computer process 61, described in greater detail below.

As shown in FIG. 5, the StreamTX computer process 61 may comprise a main process 63 and a core subroutine 65, the core subroutine 65 denoted herein as ‘GetNextStream(q)’. The main process 63 may call the core subroutine 65 to obtain a next QNode ‘q’ whose cursor element ‘C_{q}’ may be processed. The core subroutine 65 may discard the cursor element ‘C_{q}’, or may cache the cursor element and forward ‘C_{q}’ to the next element. A stack ‘S_{q}’ may be used to cache elements before the cursor ‘C_{q}’. It is known in the art to provide both a stack-type data structure and a cursor-type data structure for each node. The cursor elements may be nested from ‘bottom’ to ‘top,’ where cached elements represent partial results that can be further extended. The routine in the main process 63 may also include assembling full matches and generating tuple-extraction results with projection. As explained in greater detail below, the StreamTX computer process 61 functions to coordinate cursors with blocking.

At any point during the matching of XML patterns over XML data, one or more cursors may be associated with an element list that has become empty, causing the respective cursor to be blocked. In response, the method of the present invention may function to continue processing the XML query and emitting results by matching XML patterns over XML data with other, non-blocked cursors. This serves to continue the process of consuming incoming elements, and thus reduces the need for additional buffering in comparison to conventional methods, thereby improving the response of the tuple-extraction query.

The StreamTX computer process 61 may further utilize special data structures to support the processing of streaming XML data. For example, dynamic element queues may be maintained in place of static input lists for QNodes. The use of dynamic element queues may enable an XML element queue to grow at the “tail” as new XML elements arrive in the form of SE events, and may provide for the XML element queue to shrink after a “head” element has been processed. In addition, the cursor on an element queue may be configured to either: (i) point to a valid XML element in the queue, or (ii) assume a blocked state when the XML element queue is empty.

If the XML data is not in the form of SAX events, an SAX parser may be used on the incoming XML data. XML elements whose ‘EE’ events have not arrived have open-end values. As can be appreciated by one skilled in the art, ancestor-descendant and parent-child relationships may be evaluated with open-ended region codes. Given two XML elements ‘u’ and ‘v’, if element ‘u’ is open-ended, then ‘u’ is an ancestor element of ‘v’ if u.start<v.start. If ‘u’ is not open-ended, then ‘u’ is an ancestor element of the element ‘v’ if u.start<v.start<u.end. The open-ended region code of an XML element may be completed when the ‘EE’ event for the open-ended element has arrived.

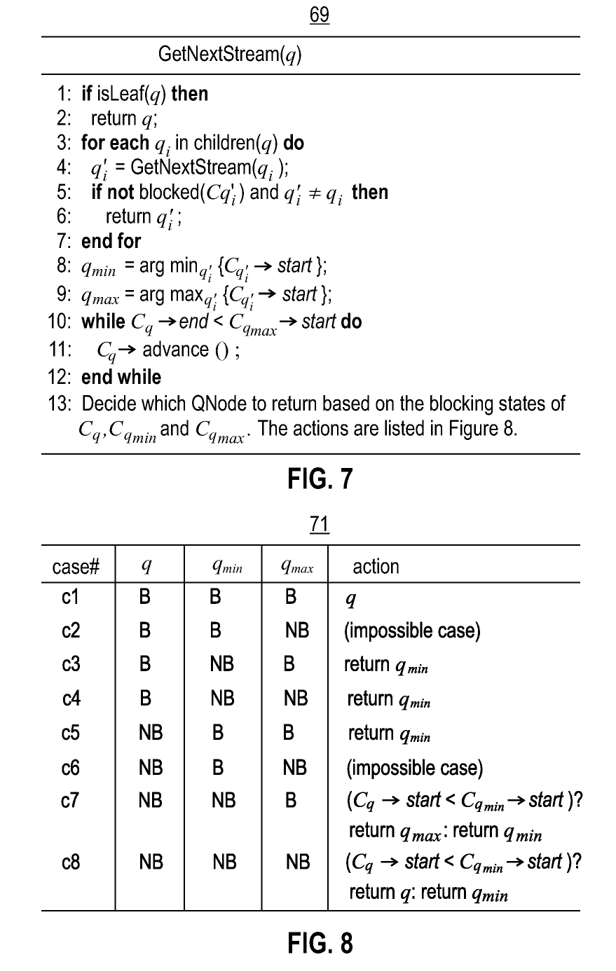

The code 69 for the core subroutine 65, ‘GetNextStream’, shown in FIG. 7, functions to block itself and to return a blocked QNode if it cannot proceed without seeing more SAX events. To implement such a processing paradigm, given each incoming SAX event, the main process 63 may be invoked which repeatedly calls the core subroutine 65 to obtain the next element for processing until the core subroutine 65 returns a blocked QNode. That is, the core subroutine 65 may return a QNode, either with a valid cursor element or with a blocked cursor element.

As provided for by code line five, the core subroutine 65 addresses the case where a returned QNode is a blocked QNode. If a subtree ‘qᵢ’ is blocked, this does not necessarily mean that ‘C_{qi}’ is blocked—the blocking could be caused by a blocked cursor in the subtree ‘qᵢ’. The initial part of the core subroutine 65, up to code line five, associates each of the child subtrees ‘qᵢ’ with its ‘GetNextStream(qᵢ)’ value ‘q′ᵢ’, which can be either a blocked QNode or the same as ‘qᵢ’ which has a ‘solution extension.’ As understood in the relevant art, the node ‘qᵢ’ has a solution extension if there is a solution for a sub query rooted at ‘qᵢ’ composed entirely of the cursor elements of the query nodes in the sub query. The latter part of the core subroutine 65, beginning with code line eight, functions to coordinate QNodes. The start and end values of a blocked cursor, and the end value of an open-ended region code may be specified to be a predetermined constant having a value larger than the start and end values of any completed region code. This specified requirement serves to assure that an open-ended region covers all subsequent incoming elements.

The function arg min_{q′}_{ᵢ}{C_{q′}_{ᵢ}→start}, at code line eight, returns the one QNode among all the returned QNodes that has the smallest start value, at code line four. Similarly, the function arg max_{q′}_{ᵢ}{C_{q′}_{ᵢ}→start}, at code line nine, returns a blocked QNode, if there is a blocked QNode among all the ‘q+ᵢ’ subtrees. If the end value of the QNode ‘q’ is smaller than the value of C_{q}_{ₘₐₓ}→start, at code lines ten through twelve, then the QNode ‘q’ cannot be an ancestor element of the C_{q}_{ₘₐₓ}’ and the elements for the QNode ‘q’ are skipped.

Subsequent action may be taken, in code line thirteen, in accordance with criteria summarized in a decision table 71, shown in FIG. 8. In the decision table 71, the designation ‘B’ indicates that a respective cursor is blocked, and the designation ‘NB’ indicates that a respective cursor is not blocked. Determination may be made as to which QNode is to be returned, the determination based on the blocking states of the three QNodes (‘q’, ‘qₘᵢₙ’, and ‘qₘₐₓ’). In accordance with the decision table 71, if additional SAX events occur before a QNode with a solution extension is returned, a blocked QNode may be returned. For example, for the case in the first line of the decision table 71, denoted by ‘c1’, a blocked QNode ‘q’ may be returned if all three QNodes ‘q’, ‘qₘᵢₙ’, and ‘qₘₐₓ’ are identified as being blocked. It should be understood that either ‘qₘᵢₙ’ or ‘qₘₐₓ’ may be returned instead of ‘q’, because any blocked QNode is treated similarly when returned.

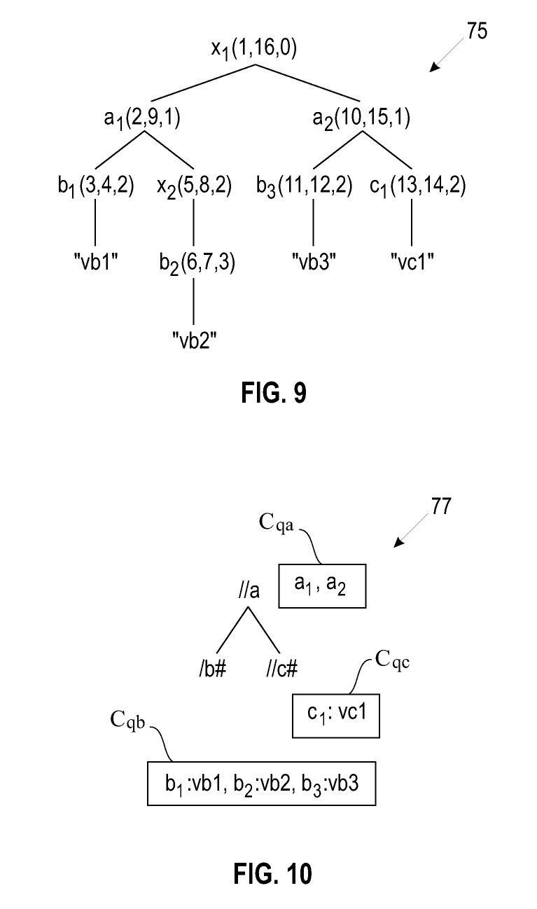

An XML data tree 75, in FIG. 9, and a data and query 77, in FIG. 10, may be used to show a running example of the core subroutine 65 ‘GetNextStream(q)’. There may be provided an input element list (not shown) associated with each node in the data tree 75. The symbol ‘q’ may be used, with or without a subscript, to refer to a QNode in the data tree 75 where, for example, the symbols ‘qₐ’, ‘q_{b}’, and ‘q_{c}’ may refer to three QNodes. The function ‘isLeaf(q)’ examines whether a QNode ‘q’ is a leaf node or not. The function ‘children(q)’ retrieves all child QNodes of ‘q’. For example, the function ‘children(qₐ)’ produces a list {q_{b}; q_{c}}.

Elements in the XML data tree 75 have been assigned region codes and have been sorted according to their ‘start’ attributes in each list. Note that the elements for extraction QNodes (such as ‘q_{b}’ and ‘q_{c}’) are also associated with text values. There may be a cursor, denoted as ‘C_{q}’, for each QNode ‘q’. Each QNode cursor ‘C_{q}’ may point to an element in the corresponding input list of ‘q’. Accordingly, both the term ‘C_{q}’ and the term ‘element C_{q}’ are used herein to mean the element to which the cursor ‘C_{q}’ points. The region code of the cursor element may be accessed by invoking ‘C_{q}→start’, ‘C_{q}→end’, and ‘C_{q}→level’. The region code of the cursor element ‘C_{q}→advance( )’ can be invoked to forward the cursor to the next element in the list for the QNode ‘q’.

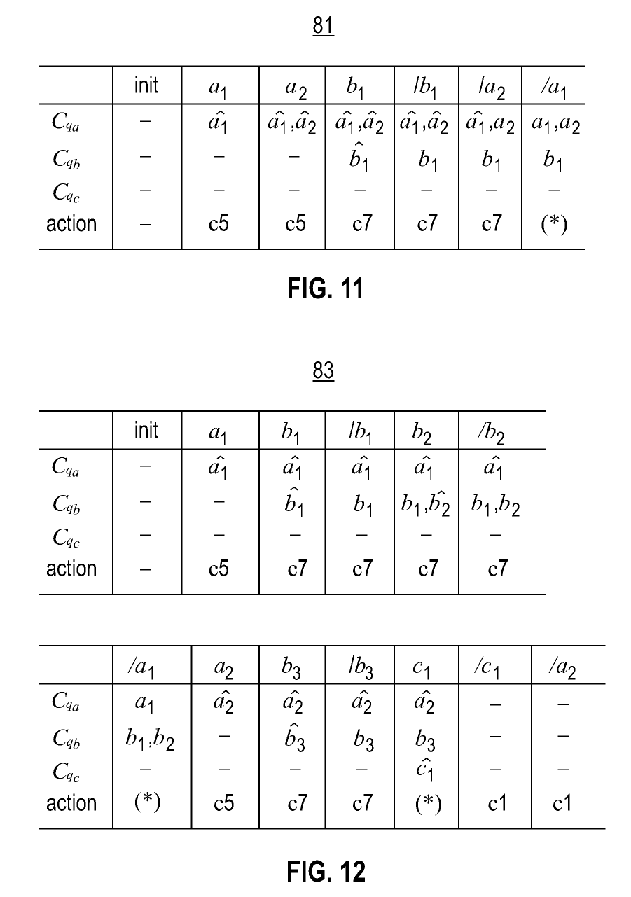

Running statistics for the XML data tree 75 and the data and query 77 are shown in a table 81 in FIG. 11. The column headers show the SAX events in the order of their arrival. In the table 81, an ‘x’ column heading represents a starting event ‘SE(x)’, a ‘/x’ represents an ending event ‘EE(x)’, and an ‘init’ heading represents an initial state. The rows identified with the cursors ‘C_{qa}’, ‘C_{qb}’, and ‘C_{qc}’ show the content of the corresponding element queue after the incoming SAX event is added to the corresponding element queue. A hat ‘(̂)’ may be used to denote an open-ended element, such as ‘â₁’. The head of an element queue is the cursor element. If the queue is empty, the respective cursor may be in a blocked state.

After each SAX event, the core subroutine 65 ‘GetNextStream(qₐ)’ may be called by the main process 63. Post-SAX event running statistics may be found in a table 83 in FIG. 12. The row in the table 83 labeled ‘action’ shows which case of the decision table 71 is used to return a QNode in the core subroutine 65. As can be seen in the table 83, the core subroutine 65 always returns a blocked QNode, except for the two columns with whose actions are denoted by an asterisk ‘(*)’. Given the event ‘EE(a₁)’, the end value of the region code of ‘a₁’ is updated. When the core subroutine 35 is called, ‘a₁’ is skipped in accordance with code line eleven, FIG. 7, since the ‘C_{qc}’ is still blocked and ‘C_{qa}’ becomes blocked. The QNode ‘q_{b}’ is returned with the element ‘b₁’, in accordance with case ‘c3’ of the decision table 71, FIG. 8. The element ‘b₂’ is similarly consumed. Accordingly, all the element queues may be empty before the event ‘SE(a₂)’ occurs.

When the event ‘SE(c₁)’ occurs, all three cursors ‘C_{qa}’, ‘C_{qb}’, and ‘C_{qc}’ may be holding valid elements â₂, b₃, and ĉ₁ respectively. The main process 63 may call the core subroutine 65 three times to consume the elements â₂, b₃, and ĉ₁. It should be understood that the QNodes corresponding to the elements â₂, b₃, and ĉ₁ are returned by cases ‘c8’, ‘c4’, and ‘c3’, respectively, in the table 71. This example shows that the main process 63 functions to consume incoming SAX events “greedily” based on the decision table 71, so that any buffer required to hold parsed elements may be kept as small as possible. In particular, the maximum length for the element queue of QNode ‘qₐ’ is ‘one’, although there are two a-elements in total. In contrast, conventional methods require that both a-elements be cached.

The core subroutine 65 may also function to ensure that elements are consumed with best efforts, without compromising the optimality of holistic twig joins. However, because holistic matching is a conservative approach in the action of blocking matching until a solution extension is found, undesirable element queues may result even with the process of waiting for blocked cursors, as described above. Accordingly, the disclosed method may include either or both of two pruning techniques, described below, to minimize the sizes of buffered element queues. It should be understood that, when a start-element event arrives, all ancestor elements of the start-element have also arrived, and that, when an end-element event arrives, all the descendant elements of the end-element have arrived.

Accordingly, when a start-element event occurs, the incoming element in the dynamic element list may be checked to determine whether there are corresponding ancestor elements to satisfy the query path. A query path is defined as a path from the root QNode to the QNode corresponding to the element in question. For example, for the QNode ‘q_{b}’ in the query and input lists 77, the QNode query path is ‘//a/b #’. If the element being checked, such as an SAX element, does not satisfy any of one or more query path patterns ending at one or more query nodes corresponding to the element in question, the element can be discarded. This first pruning technique is denoted herein as ‘query-path pruning.’

Query-path pruning may be explained with reference to the table 83, in which both b-elements are buffered. By inspection it can be seen that, when the event ‘SE(b₂)’ arrives the element ‘b₂’ does not have a parent a-element. This occurs because all the start-element events of the b₂-element ancestors have arrived when the event ‘SE(b₂)’ arrives. Judgment may be made from these arrived ancestor elements, if any. In this particular example, the only ancestor element is ‘a₁’, which is not a parent element of ‘b₂’. As a result, the element ‘b₂’ can be discarded and not added to the element queue ‘C_{qb}’.

Although the query-path pruning technique may check only the ancestor-descendant or parent-child relationship between an incoming element and the parent element queue of the incoming element, the incoming element may be checked to determine if there is a match for the query path from the root QNode to the QNode where the incoming element belongs. The query-path pruning technique can be implemented such that the cost of a match-test for each incoming element has a substantially constant value.

As can be appreciated by one skilled in the art, given a new incoming open-ended element ‘e’ to QNode ‘q’, ancestors of the open-ended element in the element queue of ‘parent(q)’ may likewise be concurrently open-ended elements and, moreover, the ancestor elements may be nested within each other. As a result, a stack of open-ended elements may be maintained for each element queue. An open-ended element may be removed from the stack upon the arrival of a corresponding ‘EE’ event. The top element of a stack maintained for an element queue of ‘parent(q)’ may be checked to determine whether the corresponding element has a parent or ancestor element in the element queue of ‘parent(q)’. It can further be appreciated that the process of query-path pruning ensures that each open or closed element ‘e’ buffered in element queues satisfies a corresponding query path. That is, there exist ancestor elements a₁, a₂, . . . aₙ such that the element path a₁→a₂→ . . . →aₙ→e satisfies the corresponding query path.

Additionally, when an end-element event occurs, and if the corresponding element does not have descendant elements to make up a match for the subtree, the element itself can be pruned as well at the corresponding descendant elements in the element queues. A second pruning technique, denoted herein as ‘existential-match pruning,’ is based on the criterion that there exists at least one subtree match for the closing element. It can be appreciated by one skilled in the art that there may be no need to instantiate all matching instances for the closing element to implement existential-match pruning.

A matching flag may be used for each non-leaf open-ended element in element queues to enable the existential-match pruning. The matching flag may be a Boolean value indicating whether the element has matching descendant elements according to the query pattern. To maintain the matching flag, the flags of all the open-ended elements along the query path may be updated whenever the ‘SE’ of a leaf QNode arrives.

To show that existential-match pruning can help reduce element buffer size, consider an incoming XML as a path with three elements: ‘a₁→a₂→b₁’, where ‘a₁’ comprises a root element and ‘b₁’ comprises a the leaf element, and consider the query ‘//a[b#]//c#’, denoted as query 77 in FIG. 10. Table 81, in FIG. 11, provides running statistics for the core subroutine 65 ‘GetNextStream(qₐ)’ without utilizing existential-match pruning. When the end-element event of ‘a₂’ (i.e., ‘/a₂’) arrives, the elements ‘a₂’ and ‘b₁’ may still be in the element queues. However, the element ‘a₂’ does not have a subtree match due to a missing c-element descendant element. If existential-match pruning has been enabled, then the flag for element ‘a₂’ is false. Therefore, both the elements ‘a₂’ and ‘b₁’ may be removed because the element ‘a₂’ is the only ancestor element of ‘b₁’. Under the extreme case where ‘a₂’ has many following sibling a-elements that have only ‘b’ descendants, existential-match pruning may be used to prune these a-elements, which otherwise would stay in the buffer until ‘EE(a₁)’ arrives.

It should be understood that cascaded pruning of descendant elements may be applied when the descendant elements do not match other valid ancestor/parent elements. Additionally, if cascaded pruning is applied, existential-match pruning may also be executed as pruned descendant elements may be clustered at the tails of corresponding element queues. The existential-match pruning technique functions to ensure that all the closed elements buffered in the queues participate in final results of tuple extraction.

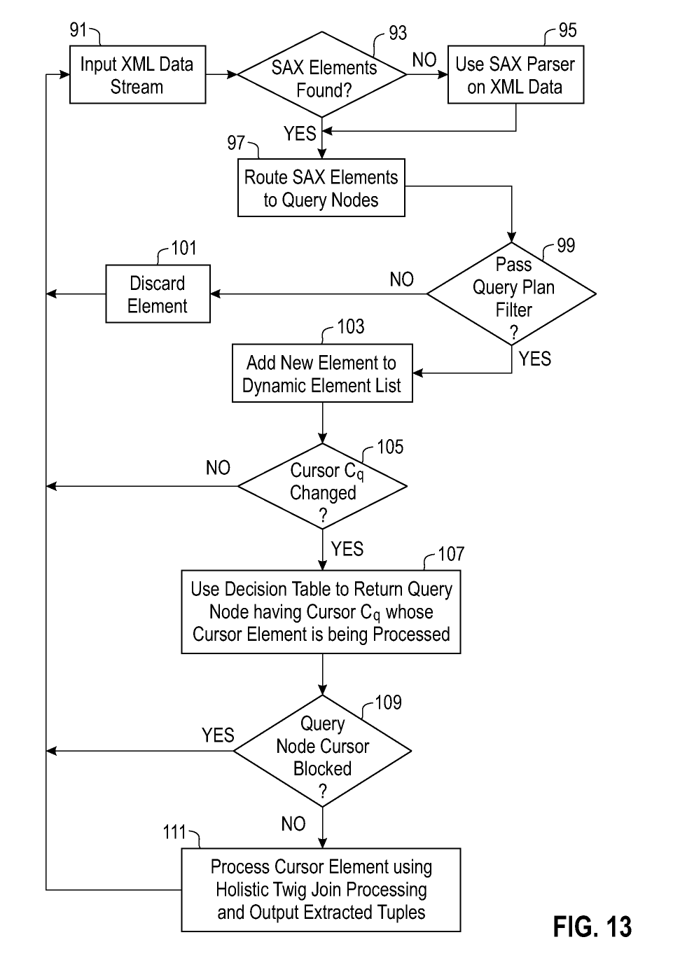

The disclosed process for querying streaming XML data may best be described with reference to a flow diagram 90, shown in FIG. 13. XML documents comprising streaming XML data may be inputted to a data processing system, at step 91. A determination may be made, at decision box 93, as to which, if any, of the XML data stream does not comprise SAX elements. An SAX parser may be used, at step 95, to parse the incoming XML document, and the SAX elements may be routed to query nodes, at step 97. The SAX parser functions to continuously parse the incoming XML documents and to push the SAX elements along the steps of the flow diagram 90. This execution task may be completed when an entire document has been parsed.

The SAX elements may be filtered by means of a query plan filter, at step 99. The filter is based on the pattern of a query plan, and serves to eliminate data not conforming to one or more predetermined query plan patterns. Non-conforming elements may be discarded, at step 101, and additional data inputted, at step 91. Conforming elements may be added or appended to the tail of each of one or more dynamic element lists having the same tag as the new element, at step 103. A determination may be made, at decision box 105, as to whether the corresponding cursor C_{q} has changed. Since a cursor points to the head of an element list, a cursor change may occur when a new element has been added or appended to an empty element list. If the cursor C_{q} is unchanged, the process may proceed to input additional XML data, at step 91.

If an incoming event or element has been encountered, at decision box 105, the cursor C_{q} may have changed and a decision table may be used to return a query node whose cursor element is being processed. That is, a non-blocked query node may be returned, even if some query nodes remain in a blocked state. The resultant query node is returned, per the decision table, and a determination is made, at decision box 109, as to whether the corresponding query node cursor is in a blocked state. If the corresponding query node cursor is blocked, the process may resume by inputting additional XML data, at step 91. If the corresponding query node cursor is not blocked, the cursor element may be processed using a holistic twig join process, at step 111, and additional XML data may be obtained, at step 91. After the cursor element has been processed, the cursor element may be discarded, and the cursor may point to the next element in the element list. If the element list has only a single element, the cursor may become blocked at this step.

Embodiments of the invention can take the form of an entirely hardware embodiment, an entirely software embodiment, or an embodiment containing both hardware and software elements. In a preferred embodiment the invention is implemented in software that includes, but is not limited to, firmware, resident software, and microcode. Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system, apparatus, or device, or a propagation medium. Examples of computer-readable media include: a semiconductor or solid state memory, magnetic tape, a removable computer diskette, a random access memory (RAM), a read-only memory (ROM), a rigid magnetic disk, and an optical disk. Current examples of optical disks include: compact disk-read only memory (CD-ROM), compact disk-read/write (CD-R/W) and (digital versatile disk) DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output devices (including, but not limited to, keyboards, displays, and pointing devices) may be coupled to the system either directly or through intervening I/O controllers. Network adapters may also be coupled to the system to enable coupling of the data processing system to other data processing systems or to remote printers or to storage devices through intervening private or public networks via transmission paths such as digital and analog communication links. Modems, cable modem and Ethernet cards are just a few of the currently available types of network adapters.

It should be understood that, while the invention has been described in the context of fully functioning computers and computer systems, those skilled in the art will appreciate that the various embodiments of the invention are capable of being distributed as a software and firmware product in a variety of forms, and that the invention applies equally regardless of the particular type of signal bearing medium used to convey the distribution. Moreover, the foregoing relates to exemplary embodiments of the invention and that modifications may be made without departing from the spirit and scope of the invention as set forth in the following claims.

What is claimed is:

1. A method for querying streaming extensible markup language data comprising:
routing elements to query nodes, said elements derived from the streaming extensible markup language data;
filtering out said elements not conforming to one or more predetermined path query patterns;
adding said remaining elements to one or more dynamic element lists;
accessing a decision table to select and return a query node related to a cursor element from said dynamic element lists; and
processing said cursor element related to said returned query node to produce an extracted tuple output.

2. The method of claim 1 wherein said step of routing elements comprises the step of using a parser on the streaming extensible markup language data to derive said elements.

3. The method of claim 1 wherein said step of accessing said decision table is performed when an incoming event or element is encountered.

4. The method of claim 1 wherein said step of processing is performed when a cursor related to said returned query node is not blocked.

5. The method of claim 4 wherein additional extensible markup language data is input when said cursor is blocked.

6. The method of claim 1 wherein said step of processing comprises the step of executing a holistic twig join process on said cursor element.

7. The method of claim 1 further comprising the steps of:
checking for an incoming element in said dynamic element list to determine if said incoming element satisfies one or more query patterns ending at one or more query nodes corresponding to an element in question; and
pruning said incoming element if said incoming element satisfies none of said path query patterns.

8. The method of claim 1 further comprising the step of pruning an element having no descendant elements for a subtree match.

9. The method of claim 8 further comprising the step of pruning descendant elements in an element queue corresponding to said element having no descendant elements for a subtree match.

10. The method of claim 8 wherein said step of pruning comprises the step of assigning a Boolean value to a non-leaf open-ended element in said element queue to indicate whether said non-leaf open-ended element has matching descendant elements.

11. The method of claim 1 wherein said query node is selected in accordance with a blocking state of at least one other query node.

12. The method of claim 1 wherein said predetermined pattern comprises a query plan pattern.

13. A method for conducting a query to extract tuple data from a data warehouse database, said method comprising the steps of:
parsing data from the data warehouse database into a plurality of simple application program interface for extensible markup language (SAX) elements;
discarding selected said SAX elements, said selected SAX elements not conforming to path query patterns based on the query, said path query plans ending at one or more query nodes corresponding to said SAX elements;
appending at least one said SAX element to a tail of a dynamic element list;
returning a said query node related to a cursor in said dynamic element list; and
processing said cursor element via a process of holistic twig join matching.

14. The method of claim 13 wherein said dynamic element list provides at least one extensible markup language element queue that grows in response to the parsing of the data from the data warehouse database.

15. The method of claim 13 wherein said query node comprises a blocked query node.

16. An apparatus for executing a query plan comprising:
a data storage device;
a computer program product in a computer useable medium including a computer readable program, wherein the computer readable program when executed on the apparatus causes the apparatus to:
access an extensible markup language data parser to parse data from said data storage device into a plurality of elements;
route said elements to query nodes;
add said elements conforming to a query plan pattern to a dynamic element list;
access a decision table to obtain a query node related to a cursor element from said dynamic element list; and
process said cursor element to produce an extracted tuple output.

17. The apparatus of claim 16 wherein the computer readable program when executed on the apparatus further causes the apparatus to prune from said dynamic element list an element satisfying no path query pattern ending at one or more query nodes corresponding to said element.

18. The apparatus of claim 16 wherein the computer readable program when executed on the apparatus further causes the apparatus to prune from said dynamic element list an element having no descendant elements for a subtree match.

19. The apparatus of claim 17 wherein said decision table provides a query node to be returned given a blocking state of at least one other query node.

20. The apparatus of claim 17 wherein the computer readable program when executed on the apparatus further causes the apparatus to:
use a chain of linked stacks to represent a query path for said cursor element; and
obtain a twig pattern match for said query path.
